(19) United States
(12) Patent Application Publication
(10) Pub. No.: US 2007/0202454 A1
(43) Pub. Date: Aug. 30, 2007

(54) "Bulk Material Cooling Device For Cooling Hot Materials That Are To Be Cooled"

(76) Inventors: Matthias Mersmann, Lichtenbusch (BE); Karl Schinke, Koln (DE)

Correspondence Address: GREER, BURNS & CRAIN, 300 S WACKER DR, 25TH FLOOR, CHICAGO, IL, 60606, US

(21) Appl. No.: 10/583,300

(22) PCT Filed: Dec. 17, 2004
(86) PCT No.: PCT/EP04/14387

§ 371 Date: May 7, 2007

(30) Foreign Application Priority Data
Dec. 18, 2003 (DE) 103 59 400.0

(51) Int. Cl. F27D 15/02

(52) U.S. Cl. 432/77

(57) ABSTRACT

The invention relates to a device for cooling bulk materials particularly hot cement clinker, comprising a fixed ventilated cooling grate and moving push elements and having an increased service life. The push elements are embodied in the form of hollow bodies with a cooling medium flowing there through and are therefore cooled internally.

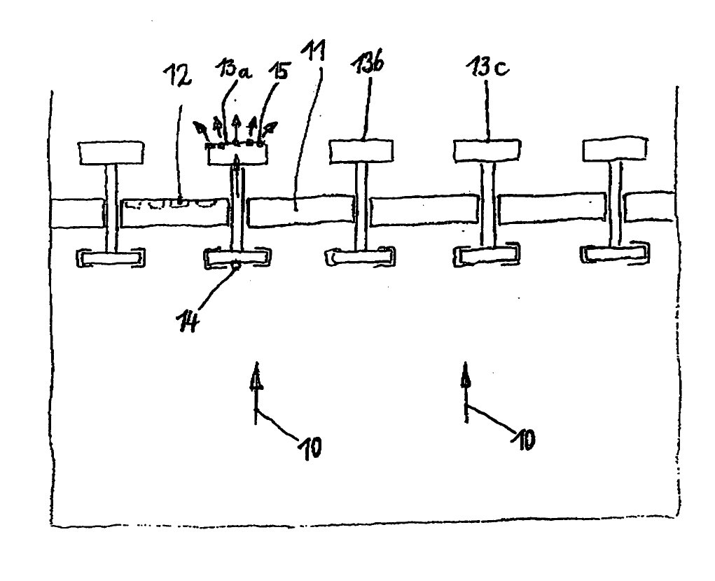

### BACKGROUND OF THE INVENTION

The invention is a bulk material cooling device with a fixed cooling grate which carries the material to be cooled (e.g. hot cement clinker) and through which cooling air flows. Above the fixed grate area, there are beam-shaped push elements arranged in several neighboring rows at right angles to the material transport direction which move backwards and forwards. They are movable between a forward-stroke position in the material transport direction and a return-stroke position and transport the material successively from the cooler start to the cooler end.

In a cement clinker production line, the hot cement clinker which is fired in a rotary furnace from calcinated cement raw mix is moved out of the oven's discharge end onto a cooler, normally dropped onto a grate cooler's cooling grate, spread out on the grate and moved on lengthwise to the cooler discharge end by a suitable means of conveyance. Simultaneously, the cooler grate and the hot bulk material layer are permeated at right angles to the conveyor direction by cooling air streams, mainly from the bottom up.

In a conventional push grate cooler, grate plate rows, which are stationary seen from the conveyor direction, alternate with backward and forward moving grate plate rows. Through a uniformly oscillating motion of all the moving grate plate rows, the hot material to be cooled is transported in batches and thereby cooled.

In order to avoid a wear problem of a push grate cooler, particularly in the overlapping area of neighboring moving and non-moving grate plate rows, a grate cooler type is known from the EP-B-1 021 692 in which the cooling grate, which cooling air flows through, is not moved, but rather stands still. Above the fixed cooling grate, there are beam-shaped push elements arranged in several neighboring rows at right angles to the material transport direction which move backwards and forwards. They are moved between a forward-stroke position in the material transport direction and a return-stroke position so that the material is moved in steps from the cooler start to the cooler end by the backwards and forwards motion of the push elements in the material bed and are thereby cooled. In a similar grate cooler type known from the DE-A-100 18 142, also understood that the push elements which move above the stationary cooler grate floor are to be divided up into at least two groups and that the push elements are to be moved together forwards in the transport direction, but to be moved back not together but separate from each other. In doing so, as little bulk bed material as possible is to be moved backwards during the backwards push of the push elements.

### SUMMARY OF THE INVENTION

The push elements which are moved in the e.g. 1000° C. hot cement clinker bulk material are however exposed to a high thermo-mechanical abrasion stress. This shortens the service life of the grate cooler.

The invention arises based on the task of creating a bulk material cooling device particularly for hot cement clinker with a fixed, ventilated cooler grate and moving push elements which nevertheless has an increased service life.

The bulk material cooling device according to the invention has movable push elements which are above the fixed grate area permeated by cooling air. They are formed as hollow bodies through which a cooling medium flows. They are thereby cooled by this cooling medium. The cooling medium can be cooling air, e.g. a part of the cooling air used in the grate cooler, which flows into the push elements through cooling air intake openings in their lower area and flows out through outlet openings in their upper area. After this, the cooling air is used as additional cooling air in the bulk material bed. Water can also be used as a cooling medium and its heat of vaporization for the cooling of the push elements. In doing so, the steam coming out of the push elements mixes with the bulk material cooling device's cooling air.

The service life is, in any case, increased in the invented bulk material cooling device due to the efficient cooling of the highly stressed push elements. This is of particular significance to a cement clinker production line, as it has to be stopped when there is a premature breakdown of the clinker grate cooling device.

### BRIEF DESCRIPTION OF THE DRAWING

The invention and its further characteristics and advantages are explained in more detail using the schematic design example in the drawing showing an end view of the grate cross section cooler.

### DETAILED DESCRIPTION OF THE DRAWING

The drawing shows a cross section of the invented grate cooler with a fixed (i.e. not movable) cooling grate (11) through which cooling air (10) flows mainly from the bottom up. Over this, the material to be cooled (not pictured), e.g. hot cement clinker, can be moved perpendicular to the drawing sheet from the material intake to the material outlet. The cooler grate (11) an be put together from individual modules which are advantageously equipped with material channels or material pockets (12) to take up and firmly hold the material. With this, a bottom, pre-cooled material bed layer or protective layer is formed on the static cooling grate (11) during operation of the grate cooler.

Above the cooler grate (11) are several rows of neighboring push elements (13a, 13b, 13c etc.) arranged at intervals, which run at right angles to the material transport direction which is perpendicular to the drawing sheet. Their beam-shaped tops extend into the e.g. 1000° C. material bed (not pictured) from below. These push elements are driven from below the cooler grate (11) such that they are moved forward together perpendicular to the drawing sheet to a forward-stroke position in the material transport direction and together, or at separate time intervals, backwards. Through this, the material to be cooled is successively transported from the cooler start to the cooler end.

The push elements (13a to 13c), which are exposed to high thermo-mechanical abrasion stress, are formed as hollow bodies in this invention. Cooling air flows through them and they are thus cooled from the inside. Through this, the service life of the push elements, and with that the service life of the bulk material cooling device, is increased. In addition, the push elements (13a to 13c etc) each feature cooling air intake openings (14) in their lower area below the cooling grate (11) and cooling air outlet opening in their upper area. Several sprinkler-like distributed cooling air outlet openings (15) can be arranged per beam-formed push element. The escaping cooling air which comes out of the upper end of the push elements (13a to 13c etc.) then goes into bulk material bed for the purpose of cooling it.

Uneven distribution in the hot bulk material bed, with regard to the height of the material bed, the clinker grain size, temperature profile etc, often cannot be avoided in grate coolers. Through this, there is an uneven cooling. For this reason, the push elements (13a to 13c etc.) in the invented grate cooler can be moved in a controlled way in individual and/or in selectable groups between their forward-stroke position and their return-stroke position. This is in order to be able to optimise the conveyance characteristics of the grate cooler and the distribution of the cement clinker both over the length and the width of the cooler. This is so that with the invented grate cooler, apart from its long service life, the thermal degree of effect can also be kept high. With the invented grate cooler it is made principally possible to specifically distribute the hot cement clinker in particular areas or zones of the cooler, to accelerate it or slow it down.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1-3. (canceled)

4. A bulk material cooler having a fixed cooling grate which carries bulk material to be cooled and through which a cooling gas flows, beam-shaped push elements arranged above the fixed grate area in several neighboring rows at right angles to a material transport direction which move backwards and forwards, the pushers being movable between a pre-stroke position in the material transport direction and a return-stroke position and transport the material successively from a cooler start to a cooler end, wherein the push elements are formed as hollow bodies through which a cooling medium flows which cools the push elements from the inside.

2. The bulk material cooler according to claim 1, wherein the push elements include cooling medium intake openings in their lower area and cooling medium outlet openings in an area which moves in a bed of the bulk material.

3. The bulk material cooler according to claim 1, wherein the cooling medium is cooling air.

4. The bulk material cooler according to claim 1, wherein the cooling medium is cooling water.

5. A bulk material cooler comprising:
an immobile cooling grate to carry bulk material to be cooled and through which a cooling gas flows,
beam-shaped push elements located above the cooling grate and arranged in several neighboring rows at right angles to a material transport direction,
the push elements being formed as hollow bodies through which a cooling medium flows which cools the push elements internally.

6. A bulk material cooler according to claim 5, wherein the push elements are arranged to move backwards and forwards between a forward-stroke position in the material transport direction and a return-stroke position to transport the material successively from a cooler start to a cooler end.

7. The bulk material cooler according to claim 5, wherein the push elements each have a lower area which includes at least one cooling medium intake opening and an area which moves in the bulk material bed which includes at least one cooling medium outlet opening.

8. The bulk material cooler according to claim 7, wherein the push elements each have a plurality of cooling medium outlet openings.

9. The bulk material cooler according to claim 5, wherein the cooling medium is air.

10. The bulk material cooler according to claim 5, wherein the cooling medium is water.

11. The bulk material cooler according to claim 5, wherein the material is hot cement clinker.

12. The bulk material cooler according to claim 5, wherein the push elements are arranged to move backwards and forwards together as a group.

13. The bulk material cooler according to claim 5, wherein the push elements are arranged to move backwards and forwards individually.

14. A bulk material cooler comprising:
a cooling grate to carry material to be cooled and through which a cooling gas flows,
beam-shaped push elements located above the cooling grate and arranged substantially transverse to a material transport direction,
the push elements being formed as hollow bodies through which a cooling medium flows to cool the push elements internally.

15. A bulk material cooler according to claim 14, wherein the push elements are arranged to move backwards and forwards between a forward-stroke position in the material transport direction and a return-stroke position to transport the material successively from a cooler start to a cooler end.

16. The bulk material cooler according to claim 14, wherein the push elements each have a lower area which includes at least one cooling medium intake opening and an area which moves in the bulk material bed which includes at least one cooling medium outlet opening.

17. The bulk material cooler according to claim 16, wherein the push elements each have a plurality of cooling medium outlet openings.

18. The bulk material cooler according to claim 14, wherein the cooling medium is air.

19. The bulk material cooler according to claim 14, wherein the cooling medium is water.

20. The bulk material cooler according to claim 14, wherein the material is hot cement clinker.

21. The bulk material cooler according to claim 14, wherein the push elements are arranged to move backwards and forwards together as a group.

22. The bulk material cooler according to claim 14, wherein the push elements are arranged to move backwards and forwards individually.

23. The bulk material cooler according to claim 14, wherein the push elements are arranged in a plurality of adjacent rows.
